(19) United States
(12) Patent Application Publication
(10) Pub. No.: US 2007/0045912 A1
(43) Pub. Date: Mar. 1, 2007

(54) Production method of dielectric ceramic composition

(75) Inventors: Hiroshi Sasaki, Nikaho-shi (JP); Tsutomu Odashima, Nikaho-shi (JP); Tomoaki Nonaka, Nikaho-shi (JP); Matsumi Watanabe, Nikaho-shi (JP)

Correspondence Address: OLIFF & BERRIDGE, PLC, P.O. BOX 19928, ALEXANDRIA, VA, 22320, US

(73) Assignee: TDK Corporation, Tokyo (JP)

(21) Appl. No.: 11/509,651

(22) Filed: Aug. 25, 2006

(30) Foreign Application Priority Data
Aug. 30, 2005 (JP) 2005-249841

(51) Int. Cl. C04B 35/64; B28B 1/00

(52) U.S. Cl. 264/681

(57) ABSTRACT

A production method of a dielectric ceramic composition having a main component containing a compound having a perovskite crystal structure of the general formula ABO₃ (where, A is at least one type of element selected from Ba, Ca, Sr, and Mg, and B is at least one type of element selected from Ti, Zr, and Hf), having a step of synthesizing an ABO₃ powder by a liquid phase method or solid phase method, a step of heat treating said synthesized ABO₃ powder to remove gas ingredients contained in said ABO₃ powder, and a step of firing a dielectric ceramic composition material including said ABO₃ powder from which the gas ingredient has been removed.

### BACKGROUND OF THE INVENTION

1. Field of the Invention

The present inventions relates to a production method of a dielectric ceramic composition used as a dielectric layer of for example a multilayer ceramic capacitor or other electronic device.

2. Description of the Related Art

Multilayer ceramic capacitors, as one example of electronic devices, are being widely used due to their small size, large capacity, and high reliability. Large numbers are being used in electrical apparatuses and electronic apparatuses.

A multilayer ceramic capacitor is usually produced by successively stacking an internal electrode layer paste and dielectric layer slurry (paste) by the sheet method, printing method, etc. and firing the stack. For the internal electrodes, generally Pd or a Pd alloy is used, but Pd is expensive, so relatively inexpensive Ni and Ni alloys have been coming into use. However, when forming the internal electrodes by Ni or an Ni alloy, if firing in the atmosphere, the electrodes will end up oxidizing. For this reason, in general, after the binder is removed, the stack is fired at an oxygen partial pressure lower than the equilibrium oxygen partial pressure of Ni and NiO and then heat treated so as to reoxidize the dielectric layers.

As the dielectric material for forming the dielectric layers after firing, BaTiO₃ or another dielectric oxide having a perovskite crystal structure of the general formula ABO₃ is mainly used.

These dielectric materials are synthesized by the solid phase method, oxalate method or other liquid phase method etc. Specifically, for example, as a method using the solid phase method to produce BaTiO₃, it is possible to mix, calcine, and crush starting materials comprised of BaCO₃ and TiO₂ to obtain a BaTiO₃ powder (for example, Japanese Patent Publication (A) No. 11-199318).

Further, as a method using one type of liquid phase method, that is, the oxalate method, to produce BaTiO₃, for example, it is possible to prepare TiCl₄ and Ba(NO₃)₂, weigh theses, use oxalic acid to cause them to precipitate as barium titanyl oxalate {BaTiO(C₂O₄).4H₂O}, and thermal decompose the obtained precipitate by heating at 10000° C. or more so as to obtain a BaTiO₃ powder (for example, Japanese Patent Publication (A) No. 11-92220).

On the other hand, in recent years, the increasing smaller size and higher performance of apparatuses have led to increasing tougher depends for making electronic devices further smaller in size, larger in capacity, lower in price, and higher in reliability. For this reason, multilayer ceramic capacitors are also being required to be made smaller in size and larger in capacity. To achieve this smaller size and larger capacity, the BaTiO₃ and other dielectric materials forming the main component of the dielectric layers are being required to be further improved in characteristics, such as specific permittivity.

### SUMMARY OF THE INVENTION

An object of the present invention, in consideration of this situation, is to provide a production method of a dielectric ceramic composition improving the specific permittivity of the material itself of the main component forming the dielectric ceramic composition (dielectric oxide having a perovskite crystal structure of the general formula ABO₃) and thereby enabling improvement of the specific permittivity without causing a deterioration of the other characteristics.

To achieve this object, the inventors engaged in intensive studies on the material of the main component forming the dielectric ceramic composition (dielectric oxide having a perovskite crystal structure of the general formula ABO₃) and as a result discovered that the material of the main component contains a small amount of a gas ingredient and that removing this gas ingredient enables higher crystallization of the material of the main component and as a result the specific permittivity can be improved and thereby completed the present invention.

That is, a production method of a dielectric ceramic composition according to a first aspect of the present invention provides
a production method of a dielectric ceramic composition having a main component containing a compound having a perovskite crystal structure of the general formula ABO₃ (where, A is at least one type of element selected from Ba, Ca, Sr, and Mg, and B is at least one type of element selected from Ti, Zr, and Hf), having
a step of synthesizing an ABO₃ powder by a liquid phase method,
a step of heat treating the synthesized ABO₃ powder to remove gas ingredients contained in the ABO₃ powder, and
a step of firing a dielectric ceramic composition material including the ABO₃ powder from which the gas ingredient has been removed.

In the first aspect of the invention, preferably, the liquid phase method is a method selected from an oxalate method, hydrothermal synthesis method, and alkoxide method.

A production method of a dielectric ceramic composition according to a second aspect of the present invention provides
a production method of a dielectric ceramic composition having a main component containing a compound having a perovskite crystal structure of the general formula ABO₃ (where, A is at least one type of element selected from Ba, Ca, Sr, and Mg, and B is at least one type of element selected from Ti, Zr, and Hf), having
a step of synthesizing an ABO₃ powder by a solid phase method,
a step of heat treating the synthesized ABO₃ powder to remove gas ingredients contained in the ABO₃ powder, and
a step of firing a dielectric ceramic composition material including the ABO₃ powder from which the gas ingredient has been removed.

In the second aspect of the invention, there method preferably further has a step of crushing the ABO₃ powder synthesized by the solid phase method before heat treating the ABO₃ powder.

In the first aspect and second aspect of the invention, preferably the heat treatment temperature when heat treating the ABO₃ powder is 400 to 1000° C.

Further, the first aspect and second aspect of the invention, the gas ingredient removed by the heat treatment is not particularly limited so long as it is included in the ABO₃ crystal and is gasified by heating, but for example carbon dioxide gas etc. may be mentioned.

The electronic device according to the present invention contains the dielectric ceramic composition produced by any of the above methods. The electric device according to the present invention is not particularly limited, but a multilayer ceramic capacitor, piezoelectric device, chip inductor, chip varistor, chip thermistor, chip resistor, or other surface mounted device chip type electronic device (SMD) may be illustrated.

According to the method of the present invention, the ABO₃ powder synthesized by the liquid phase method or solid phase method (where, A is at least one type of element selected from Ba, Ca, Sr, and Mg, and B is at least one type of element selected from Ti, Zr, and Hf) is heat treated to remove the gas ingredient. For this reason, ABO₃ powder as the main component material can be improved in crystallinity. As a result, the main component material itself (ABO₃ powder itself) can be improved in specific permittivity and in turn the dielectric ceramic composition can be improved in specific permittivity.

Further, by applying the dielectric ceramic composition produced by the method of the present invention to the dielectric layers of a multilayer ceramic capacitor or other electronic device, in addition to the effect of improving the specific permittivity, it is possible to prevent cracking due to the escape of gas caused by the expansion of gas ingredients contained in the main component material (ABO₃ powder) at the tine of firing and to improve electronic devices in productivity and reliability.

### BRIEF DESCRIPTION OF THE DRAWINGS

Below, embodiments of the present invention will be explained in detail based on the drawings, in which

FIG. 1 is a sectional view of a multilayer ceramic capacitor according to an embodiment of the present invention,

FIG. 2 is a view for explaining the production method of the main component material according to an embodiment of the present invention,

FIG. 3A is an SEM photo of the main component material before heat treatment according to an example of the present invention, while FIG. 3B is an SEM photo of the rain component material after heat treatment for removing the gas ingredient,

FIG. 4 is a view of an X-ray diffraction pattern of the main component material according to an example of the present invention, and

FIG. 5 is a view of a TG curve of the main component material according to an example of the present invention.

### DESCRIPTION OF THE PREFERRED EMBODIMENTS

### First Embodiment

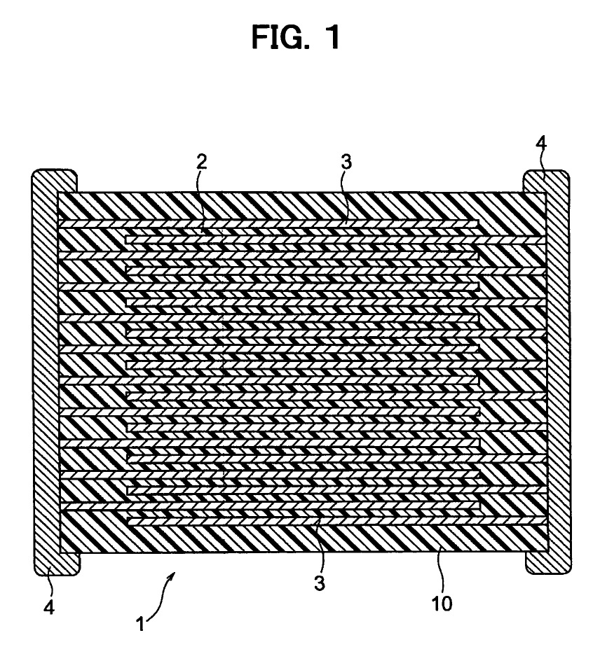

Below, a first embodiment of the present invention will be explained. In the first embodiment, as the electronic device, a multilayer ceramic capacitor 1 shown in FIG. 1 is illustrated. Its structure and production method will be explained.

Multilayer Ceramic Capacitor

As shown FIG. 1, a multilayer ceramic capacitor 1 according to an embodiment of the present invention has a capacitor element body 10 comprised of dielectric layers 2 and internal electrode layers 3 alternately stacked. The two ends of the capacitor element body 10 are formed with a pair of external electrodes 4 connected to alternately arranged internal electrode layers 3 inside the element body 10. The capacitor element body 10 is not particularly limited in shape, but normally is a parallelepiped shape. Further, its dimensions are not particularly limited and may be made suitable dimensions in accordance with the application.

The internal electrode layers 3 are stacked so that their end faces are alternately exposed at the surfaces of the two facing ends of the capacitor element body 10. The pair of external electrodes 4 are formed at the two ends of the capacitor element body 10 and are connected to the exposed end faces of the alternately arranged internal electrode layers 3 to form a capacitor circuit.

The dielectric layers 2 contain the dielectric ceramic composition produced by the method according to a first aspect of the present invention.

The dielectric ceramic composition produced by the method according to the first aspect of the invention has a main component including a compound having a perovskite crystal structure of the general formula ABO₃ (where, A is at least one type of element selected from Ba, Ca, Sr, and Mg, and B is at least one type of element selected from Ti, Zr, and Hf).

As such a main component, specifically BaTiO₃ having an A site element comprised of the element Ba and a B site element comprised of the element Ti, (Ba,Ca)TiO₃, (Ba,Sr)TiO₃, or (Ba,Ca,Sr)TiO₃ where part of the element Ba is substituted, or these where the A site element is substituted by Mg, (Ca,Sr)TiO₃ having an A site element comprised of the element Ca and the element Sr, etc. may be mentioned. Further, regarding the B site element, for example, Ba(Ti,Zr)O₃, Ba(Ti,Hf)O₃, Ba(Ti,Zr,Hf)O₃, etc. where the element Ti of the above BaTiO₃ is substituted by the element Zr or the element Hf may be mentioned. Note that in the above formula, the ratios of elements forming the A site and the elements forming the B site may be any ratios. The amount of oxygen (O) may be deviated somewhat from the stoichiochemical composition of the above formula. Further, the main component is not limited to the above. The A site elements and B site elements may be combined in any way according to the desired performance.

In the present embodiment, among the above main components, BaTiO₃ and (Ba,Ca)TiO₃ are particularly preferable and BaTiO₃ is more preferable. By using BaTiO₃ as the main component, a higher specific permittivity can be obtained.

The dielectric ceramic composition may have, in addition to the above main component, various subcomponents added to it in accordance with need. Such subcomponents are not particularly limited and may be suitably selected in accordance with the targeted characteristics.

The dielectric layers 2 are not particularly limited in thickness, but in the present embodiment, they are reduced in thickness to preferably 3 μm or less, more preferably 2 μm or less, still more preferably 1 μm or less. This is to deal with the smaller sizes and large capacities.

Further, the dielectric crystal particles forming the dielectric layers 2 are not particularly limited in particle diameter, but in the present embodiment are reduced in particle diameter to preferably 1.00 μm or less, more preferably 0.20 μm or less. If the dielectric crystal particles are too large in particle diameter, when reducing the thicknesses of the dielectric layers, IR defects end up easily occurring. For this reason, the dielectric layers end up becoming harder to reduce in thickness.

The external electrodes 4 are not particularly limited in material, but usually copper or a copper alloy, nickel or nickel alloy, etc. may be used. Silver or an alloy of silver and palladium etc. may also be used. The external electrodes 4 are not particularly limited in thickness, but are usually 10 to 50 μm or so.

The multilayer ceramic capacitor 1 may be suitably determined in shape or application according to the purpose or application. If the multilayer ceramic capacitor 1 is a rectangular parallelepiped in shape, usually it has a height of 0.4 to 5.6 mm, preferably 0.4 to 3.2 mm, a width of 0.2 to 5.0 mm, preferably 0.2 to 1.6 mm, and a thickness of 0.1 to 1.9 mm, preferably 0.3 to 1.6 mm or so.

Production Method of Multilayer Ceramic Capacitor 1

The multilayer ceramic capacitor 1 of the present embodiment, like a conventional multilayer ceramic capacitor, is produced by preparing a green chip by the usual printing method or sheet method using a paste, firing this, then printing or transferring external electrodes and again firing it. Below, the production method will be explained specifically.

First, the dielectric ceramic composition material contained in the dielectric layer paste will be prepared. The dielectric ceramic composition material contains the material of above-mentioned main component U powder) and the material of the subcomponents added as required.

Preparation of Main Component Material

Synthesis of Main Component Material

In the present embodiment (first embodiment),, the main component material (ABO₃ powder) is synthesized by the liquid phase method. As the liquid phase method, the conventionally known oxalate method, hydrothermal synthesis method, alkoxide method, etc. may be mentioned. By using the liquid phase method to synthesize the main component material, a fine material powder having a sharp particle diameter distribution can be obtained. Note that a main component material obtained by the liquid phase method has an average particle diameter of preferably 0.1 to 0.5 μm in range.

When using the oxalate method to for example obtain a main component material comprised of a BaTio₃ powder, the following method may be employed. That is, first, starting materials comprised of a barium chloride solution and a titanium chloride solution are prepared. Next, these barium chloride solution and titanium chloride solution are mixed in a predetermined ratio, then oxalic acid is added to this mixture to cause barium titanyl oxalate to precipitate. Next, this barium titanyl oxalate is heat treated to synthesize a BaTiO₃ powder.

When using the hydrothermal synthesis method to obtain for example a main component material comprised of a BaTiO₃ powder, the following method may be employed. That is, first, starting materials comprised of a barium hydroxide solution and a titanium hydroxide-containing slurry are prepared. Next, a barium hydroxide solution and a titanium hydroxide-containing slurry are mixed by a predetermined ratio, then the mixture is charged into a high pressure reactor and heat treated under high pressure conditions to synthesize a BaTiO₃ powder.

Further, when using the alkoxide method to obtain for example a main component material comprised of a BaTiO₃ powder, the following method may be employed. That is, first, starting materials comprised of barium alcoholate and titanium alcoholate are prepared. Next, the barium alcoholate and titanium alcoholate are dispersed in alcohol or another organic solvent, ion exchanged water or distilled water is added to this dispersion, then the mixture is aged and finally heat treated to synthesize a BaTiO₃ powder.

Heat Treatment of Main Component Materials

Next, the main component material (for example, BaTiO₃ powder) obtained by each of the above methods is heat treated. This heat treatment is for removing the carbon dioxide gas or other gas ingredient contained in the main component material obtained above. By performing this heat treatment, it is possible to increase the crystallization of the main component material and as a result improve the specific permittivity of the main component itself.

The present embodiment has as its most significant characteristic the heat treatment of the main component synthesized by the above methods. In particular, a general main component material obtained by the above methods contains small amounts of carbon dioxide gas and other gas ingredients. Removal of these gas ingredients enables higher crystallization of the main component material and as a result enables improvement of the specific permittivity. The embodiment is based on this new discovery.

Note that this heat treatment differs from the heat treatment performed, for example, when using a main component material comprised of BaTiO₃ and causing various types of materials forming BaTiO₃ (Ba compound and Ti compound) to react to obtain BaTiO₃ crystals. That is, this heat treatment for removal of the gas ingredient is performed on the already reacted perovskite structure (for example, BaTiO₃ ) main component material.

As the conditions of this heat treatment, the heat treatment temperature is preferably 400 to 1000° C., more preferably 500 to 950° C., furthermore preferably 700 to 900° C. If the heat treatment temperature is too low, the removal of the gas ingredient contained in the main component material is insufficient and the effect of improvement of the specific permittivity cannot be obtained. On the other hand, if the heat treatment temperature is too high, the main component material ends up becoming greater in particle diameter and the main component material becomes difficult to make fine in particle diameter. As a result, when making the dielectric layers thinner, the IR defect rates ends up becoming poorer. For this reason, making the dielectric layers thinner ends up becoming obstructed.

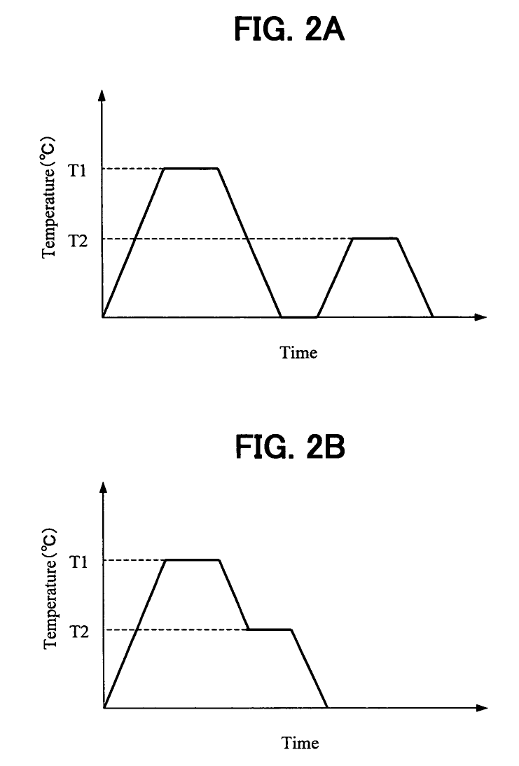

Note that among the above liquid phase methods, when employing the oxalate method or other method wherein heat treatment is performed by a relatively high temperature at the time of synthesis (in particular, a temperature higher than the temperature of heat treatment for removal of the gas ingredient), as shown in FIG. 2A, to synthesize the main component material, it is possible to perform heat treatment at the temperature T1, then cool once to near room temperature, then perform heat treatment for real of the gas ingredient (temperature T2) or, as shown in FIG. 2B, to perform heat treatment at the temperature T1 then continue with heat treatment at the temperature T2.

At the step shown in FIG. 2A, the rate of temperature rise during the heat treatment for removal of any gas ingredient (temperature T2) is preferably 50 to 400° C./hour, more preferably 100 to 300° C./hour. Further, the holding time (time held at temperature T2) is preferably 0.5 to 4.0 hours, more preferably 1.0 to 3.0 hours. Further, the rate of temperature fall when lowering the temperature from T2 to near room temperature is preferably 50 to 400° C./hour, more preferably 100 to 300° C./hour. Note that in the step shown in FIG. 2B, other than there being no temperature raising step, the conditions may be made the same as the step shown in FIG. 2A.

Preparation of Pastes

Next, the above obtained main component materials and any subcomponent materials to be added as required are mixed to obtain dielectric ceramic composition materials.

Note that when preparing the dielectric ceramic composition materials, after mixing the main component materials and subcomponent materials, they may be calcined.

The subcomponent materials used may be oxides or their mixtures or complex oxides, but it is also possible to suitably select and mix various compounds forming the above oxides or complex oxides by firing, for example, carbonates, oxalates, nitrates, hydroxides, organometallic compounds, etc. Further, the subcomponent materials may be used calcined.

Next, the above obtained dielectric ceramic composition materials are made to be coatings to prepare the dielectric layer pastes.

Each dielectric layer paste may be an organic coating comprised of a dielectric ceramic composition materials and organic vehicle kneaded together or a water-based coating.

The organic vehicle is a binder dissolved in an organic solvent. The binder used for the organic vehicle is not particularly limited and may be suitably selected from ethyl cellulose, polyvinyl butyral, and other usual various types of binders. Further, the organic solvent used is also not particularly limited and may be suitably selected in accordance with the method of use, such as printing method and sheet method, from terpineol, butyl carbitol, acetone, toluene, and other various types of organic solvents.

Further, when making the dielectric layer paste a water-based coating, a water-based vehicle comprised of a water-soluble binder or dispersant etc. dissolved in water should be kneaded with the dielectric material. The water-soluble binder used for the water-based vehicle is not particularly limited, but, for example, polyvinyl alcohol, cellulose, a water-soluble acryl resin, etc. may be used.

The internal electrode layer pastes are prepared by kneading the above various types of conductive materials comprised of conductive metals or their alloys or various types of oxides, organometallic compounds, resinates, etc. forming the above conductive materials after firing and the above organic vehicle and the above organic vehicle.

The external electrode pastes may be prepared in the same way as the internal electrode layer pastes.

The contents of the organic vehicles in the above pastes are not particularly limited. The usual contents, for example, for the binder, 1 to 5 wt % or so and for the solvent, 10 to 50 wt % or so, may be used. Further, the pastes may, in accordance with need, contain various types of additives selected from dispersants, plasticizers, dielectrics, insulators, etc. The total content of these is preferably 10 wt % or less.

Formation of Green Chips

When using the printing method the dielectric layer paste and internal electrode layer paste are printed in successive layers on a PET or other substrate, then the stack is cut to predetermined sizes which are then peeled off from the substrate to obtain green chips.

Further, when using the sheet method, the dielectric layer paste is used to form a green sheet, this is printed with the internal electrode layer paste, then this is stacked to form a green chip.

Firing of Green Chips Etc.

Before firing, a green chip is treated to remove the binder. The conditions of treatment for removing the binder may be suitably determined in accordance with the type of the conductive material in the internal electrode layer paste, but when using as the conductive material Ni or an Ni alloy or other base metal, the oxygen partial pressure in the binder removal treatment atmosphere is preferably 10⁻⁴⁵ to 10⁵ Pa. If the oxygen partial pressure is less than that range, the effect of binder removal falls. Further, if the oxygen partial pressure exceeds that range, the internal electrode layers tend to oxidize.

As other binder removal treatment conditions, the rate of temperature rise is preferably 5 to 300° C./hour, more preferably 10 to 100° C./hour, the holding temperature is preferably 180 to 400° C., more preferably 200 to 350° C., and the temperature holding time is preferably 0.5 to 24 hours, more preferably 2 to 20 hours. Further, the atmosphere is preferably made the air or a reducing atmosphere. As the atmosphere gas in the reducing atmosphere, for example, a mixed gas of N₂ and H₂which is wetted is preferably used.

The atmosphere when firing a green chip may be suitably selected in accordance with the type of the conductive material in the internal electrode layer paste, but when using a conductive material comprised of Ni or an Ni alloy or other base metal, the oxygen partial pressure in the firing atmosphere is preferably 10⁻⁷ to 10⁻³ Pa. If the oxygen partial pressure is less than that range, the conductive material of the internal electrode layers will abnormally sinter ad will end up causing disconnection in some cases. Further, if the oxygen partial pressure is over the range, the internal electrode layers tend to oxidize.

Further, the holding temperature at the time of firing is preferably 1100 to 1400° C., more preferably 1200 to 1380° C., furthermore preferably 1260 to 1360° C. If the holding temperature is less than the range, the densification becomes insufficient, while if over that range, the internal electrode layers will abnormally sinter causing electrode disconnection, the internal electrode layer materials will diffuse resulting in deterioration of the capacity-temperature characteristic, or the dielectric ceramic composition will easily be reduced.

As other firing conditions, the rate of temperature rise is preferably 50 to 500° C./hour, more preferably 200 to 300° C./hour, the temperature holding time is preferably 0.5 to 8 hours, more preferably 1 to 3 hours, and the cooling rate is preferably 50 to 500° C./hour, more preferably 200 to 300° C./hour. Further, the firing atmosphere is preferably made a reducing atmosphere. As the atmosphere gas, for example, a mixed gas of N₂ and H₂ which is wetted is preferably used.

When firing in a reducing atmosphere, it is preferable that the capacitor element body is annealed. The annealing is treatment for reoxidizing the dielectric layer. This enables the IR life to be remarkably lengthened, so the reliability is improved.

The oxygen partial pressure in the annealing atmosphere is preferably 0.1 Pa or more, in particular 0.1 to 10 Pa. If the oxygen partial pressure is less than this range, reoxidation of the dielectric layers is difficult, while if over that range, the internal electrode layers tend to oxidize.

The holding temperature at the time of annealing is preferably 1100° C. or less, particularly 500 to 1100° C. If the holding temperature is less than that range, the oxidation of dielectric layers is insufficient, so the IR becomes low and the IR life easily becomes shorter. On the other hand, if the holding temperature is over that range, the internal electrode layers oxidize and fall in capacity. Not only this, the internal electrode layers end up reacting with the dielectric material and therefore deterioration of the capacity-temperature characteristic, a drop in the IR, and a drop in the IR life easily occur. Note that the annealing may also be comprised of just a temperature raising process and a temperature lowering process. That is, the temperature holding time may also be made zero. In this case, the holding temperature is synonymous with the maximum temperature.

As other annealing conditions, the temperature holding time is preferably 0 to 20 hours, more preferably 2 to 10 hours, and the cooling rate is preferably 50 to 500° C./hour, more preferably 100 to 300° C./hour. Further, as the atmosphere gas in the annealing, for example wetted N₂ gas etc. is preferably used.

To wet the N₂ gas or mixed gas etc. in the above treatment to remove the binder, firing, and annealing, for example a wetter etc. may be used. In this case, the water temperature is preferably 5 to 75° C. or so.

The treatment to remove the binder, firing, and annealing may be performed consecutively or independently. When performing these consecutively, after the treatment to remove the binder, preferably the atmosphere is changed without cooling, then the temperature is raised to the holding temperature at the time of firing to fire the chip, then the chip is cooled and the atmosphere changed when reaching the holding temperature of annealing to anneal the chip. On the other hand, when performing these independently, preferably, at the time of firing, the chip is raised in temperature to the holding temperature at the time of treatment to remove the binder in an N₂ gas or wetted N₂ gas atmosphere, then the atmosphere is changed and the chip continues to be raised in temperature. Preferably, the chip is cooled to the holding temperature at the time of annealing, then the atmosphere is again changed to an N₂ or a wetted N₂ gas atmosphere and the chip continues to be cooled. Further, at the time of annealing, it is also possible to raise the chip in temperature to the holding temperature in an N₂ gas atmosphere, then change the atmosphere or to perform the entire annealing process in a wetted N₂ gas atmosphere.

The thus obtained capacitor element body may be for example end polished by barrel polishing, sandblasting, etc. and printed or transferred and fired with the external electrode paste to form the external electrodes 4. The firing conditions of the external electrode paste are preferably, for example, a mixed gas of wet N₂ and H₂, 600 to 800° C., and 10 minutes to 1 hour or so. Further, in accordance with need, the external electrodes 4 are plated etc. to form covering layers.

The thus produced multilayer ceramic capacitor of the present invention is mounted on a printed circuit board by soldering etc. and used for various types of electronic equipment.

### Second Embodiment

Below, a second embodiment of the present invention will be explained.

In the second embodiment as well, in the same way as the first embodiment, an electronic device comprised of the multilayer ceramic capacitor 1 shown in FIG. 1 is illustrated. Its structure and production method will be explained.

The second embodiment is configured the same as in the first embodiment except for synthesizing the main component material forming the dielectric ceramic composition (dielectric layer 2) by the solid phase method. Below, the production method of the main component material in the second embodiment will be explained.

Preparation of Main Component Material

Synthesis of Main Component Material

In the present embodiment (second embodiment), the main component material (ABO₃ powder) is synthesized by the solid phase method (calcination method). As the solid phase method, a conventionally known method may be employed. By using the solid phase method to synthesize the main component material, it is possible to make the main component composition multi-dimensional relatively easily.

When using the solid phase method to obtain for example a main component material comprised of a BaTiO₃ powder, the following method may be employed. That is, first, starting materials comprised of barium carbonate and titanium dioxide are prepared. Next, the barium carbonate and titanium dioxide are mixed, then calcined to cause these materials to react and form BaTiO₃. The calcination is usually performed at preferably 900 to 1200° C., more preferably 950 to 1100° C. in temperature for preferably 0.5 to 4.0 hours, more preferably 1.0 to 3.0 hours. If the calcination temperature is too high, the BaTiO₃ powder ends up growing too much in particle diameter and crushing the BaTiO₃ powder to increase the fineness ends up becoming difficult.

Next, the obtained BaTiO₃ is crushed to obtain the BaTiO₃ powder. The crushed average particle diameter is preferably 0.1 to 0.8 μm in range.

Heat Treatment of Main Component Material

Next, each of the main component materials (for example, BaTiO₃ powder) obtained by the above methods is heat treated.

The heat treatment conditions may be made the same as the above first embodiment. In the present embodiment (second embodiment), the BaTiO₃ obtained by the calcinations is crushed to a desired particle diameter, then is heat treated to remove the gas ingredients. For this reason, compared with the case of heat treatment without crushing the gas ingredients can be removed even at a relatively low temperature, therefore the problem of excessive particle diameter growth when raising the heat treatment temperature can be effectively prevented while removing the gas ingredients.

As opposed to this, when for example using the above calcination to perform the heat treatment for removing the gas ingredients, the main component material does not become finer, so it is necessary to raise the treatment temperature or increase the treatment time to remove the gas ingredients. As a result, the main component material ends up becoming larger in particle diameter. For this reason, if this method is employed, the formation of thinner dielectric layers ends up becoming difficult.

### Effects of Embodiments

According to the present embodiments (first embodiment and second embodiment), the main component material (for example, BaTiO₃ powder) synthesized by the liquid phase method or solid phase method is heat treated to remove the gas ingredients. For this reason, the main component material can be improved in crystallinity and as a result the main component material itself can be improved in specific permittivity and, in turn, the dielectric ceramic composition can be improved in specific permittivity.

Further, in the present embodiments (first embodiment and second embodiment), such a main component material from which the gas ingredients have been removed is used to produce the multilayer ceramic capacitor 1, so the cracking due to escape of gas caused by the expansion of the gas ingredient contained in the main component material during firing can be prevented and the multilayer ceramic capacitor 1 can be improved in productivity and reliability. In particular, this type of gas ingredient cannot be removed by the binder removal treatment usually performed before the firing, so in the past has caused cracks at the time of firing. For this reason, the present embodiment solves this problem effectively.

Above, embodiments of the present invention were explained, but the present invention is not limited to these embodiments in any way. Needless to say it may be worked in various forms within a scope not departing from the gist of the present invention.

For example, in the above embodiments, the electronic device according to the present invention was illustrated as a multilayer ceramic capacitor, but the electronic device according to the present invention is not limited to a multilayer ceramic capacitor and may be any device having dielectric layers comprised of the above compositions of dielectric ceramic compositions.

Further, the above embodiments were explained focusing on examples of use of BaTiO₃ as a main component material, but the invention may of course also be applied when using a main component material other than BaTiO₃ (for example, (Ba,Ca)TiO₃)).

### EXAMPLES

Below, the present invention will be explained based on more detailed examples, but the present invention is not limited to these examples.

### Example 1

Preparation of Main Component Material (BaTiO₃)

The following method was used to prepare the main component material (BaTiO₃ powder).

That is, first, a starting material comprised of BaTiO₃ powder synthesized by the oxalate method (specific surface area 2.8 m²/g, Ba/Ti=0.995) was prepared. Next, this BaTiO₃ powder was, heat treated at the different temperatures shown in Table 1 for 2.0 hours in the air to remove the gas ingredients and thereby prepare different main component materials (BaTiO₃ powder).

Next, each obtained main component material (BaTiO₃ powder) was measured for specific permittivity of the BaTiO₃ alone, average particle diameter, and residual CO₂ (gas ingredient) rate in the BaTiO₃ by the following methods so as to evaluate the BaTiO₃ powder as the main component material.

Specific Permittivity of BaTiO₃ Alone

The specific permittivity of the BaTiO₃ alone was measured by the following method. That is, first, each BaTiO₃ powder after the heat treatment for removal of the gas ingredient was given a binder comprised of polyvinyl alcohol resin (PVA) and press molded to obtain a diameter 12 mm, thickness 0.6 mm or so disk shaped sample. Next, the obtained disk shaped sample was treated to remove the binder and fired to obtain a disk shaped dielectric ceramic composition sample. Note that the binder removal treatment conditions were a holding temperature of 400° C., a temperature holding time of 2 hours, and an atmosphere of the air. The firing conditions were a temperature suitable for the BaTiO₃ powder synthesized by the oxalate method, that is, conditions giving the largest specific permittivity. Specifically, the conditions were made a holding temperature of 1250 to 1270° C., a temperature holding time of 2 hours, and an atmosphere of the air.

Next, each obtained disk shaped sample was coated on its two surfaces with dieter 6 mm In—Ga. These were used as electrodes to obtain samples for measurement of the specific permittivity.

Each obtain sample for measurement of the specific permittivity was measured at a reference temperature of 25° C. by a digital LCR meter (made by YHP, 4284A) for electrostatic capacity C by inputting a signal of an input signal level (measurement voltage) of 1.0 Vrms at a frequency of 1 kHz. The specific permittivity ε (no unit) was calculated based on the thickness of the disk shaped sample, the effective electrode area, and the electrostatic capacity C obtained from the measurement results. The results are shown in Table 1.

Average Particle Diameter of BaTiO₃

The average particle diameter of each BaTiO₃ was found by measuring the BaTiO₃ powder after the heat treatment for removal of the gas ingredient for the 50% diameter (D50 diameter) in number cumulative distribution by the laser beam diffraction method.

Residual CO₂ Rate in BaTiO₃

The residual CO₂ (gas ingredient) rate of each BaTiO₃ was measured by the following method. That is, each BaTiO₃ powder after the heat treatment for removal of the gas ingredient was measured for TG (the thermal weight). The results are shown in Table 1. Note that in Table 1, the residual CO₂ rate was shown by the wt % of the content of CO₂ in the case where the entire BaTiO₃ is designated as 100 wt %.

Preparation of Multilayer Ceramic Capacitor

First, as materials for preparation of the dielectric ceramic composition material, each obtained main component material (BaTiO₃) and the subcomponent materials of CaO, SiO₂, Y₂O₃, MgO, Cr₂O₃, and V₂O₅ were prepared. Next, these main component material and subcomponent materials were wet crushed by a ball mill for 19 hours, then dried to obtain a dielectric ceramic composition material. The amounts of addition of the subcomponents were adjusted to give the following ratios with respect to 100 mol of the main component in the composition after firing:
CaO: 0.83 mol
SiO₂: 1.98 mol
Y₂O₃: 1.03 mol
MgO: 1.61 mol
Cr₂O₃: 0.20 mol
V₂O₅: 0.06 mol

Note that in this example, addition of these subcomponents enables firing in a reducing atmosphere.

Next, each obtained dielectric ceramic composition material in an amount or 100 parts by weight, polyvinyl butyral resin in 10 parts by weight, a plasticizer comprised of dibutyl phthalate (DOP) in 5 parts by weight, and a solvent comprised of alcohol in 100 parts by weight were mixed by a ball mill to a paste to obtain a dielectric layer paste.

Next, Ni particles of an average particle diameter of 0.2 to 0.8 μm in 100 parts by weight, an organic vehicle (ethyl cellulose of 8 parts by weight dissolved in butyl carbitol of 92 parts by weight) in 40 parts by weight, and butyl carbitol in 10 parts by weight were kneaded by a triple roll to a paste to obtain an internal electrode layer paste.

Next, Cu particles of an average particle diameter of 0.5 μm in 100 parts by weight, an organic vehicle (ethyl cellulose resin of 8 parts by weight dissolved in butyl carbitol of 92 parts by weight) in 35 parts by weight, and butyl carbitol in 7 parts by weight were mixed to a paste to obtain an external electrode paste.

Next, the dielectric layer paste was used to form a green sheet on a PET film, this was printed on by the internal electrode layer paste, then the green sheet was peeled off from the PET film. Next, these green sheets and protective green sheets (not printed with internal electrode layer paste) were stacked and pressed to obtain a green chip. The number of sheets having internal electrodes was made four.

Next, the green chip was cut to a predetermined size and was subjected to tire binder removal treatment, fired, and annealed to obtain a multilayer ceramic sintered body.

The treatment to remove the binder was performed under conditions of a time of temperature rise of 15° C./hour, a holding temperature of 280° C., a holding time of 8 hours, and an air atmosphere.

The firing was performed at a temperature suitable for the BaTiO₃ powder synthesized by the oxalate method, that is, conditions giving the largest specific permittivity, that is, a rate of temperature rise of 200° C./hour, a holding temperature of 1250° C., a holding time of 2 hours, a cooling rate of 300° C./hour, and a wet N₂+H₂ mixed gas atmosphere (oxygen partial pressure of 10⁻⁹ atm).

The annealing was performed under conditions of a holding temperature of 900° C., a temperature holding time of 9 hours, a cooling rate of 300° C./hour, and a wet N₂ gas atmosphere (oxygen partial pressure of 10⁻⁵ atm). Note that the atmospheric gas at the time of firing and annealing was wetted using a wetter having a water temperature of 35° C.

Next, the multilayer ceramic fired body was polished at its end faces by sand blasting, then was transferred with the external electrode paste at its end faces and was fired in a wet N₂+H₂ atmosphere at 800° C. for 10 minutes to form the external electrodes and obtain a multilayer ceramic capacitor sample of the configuration shown in FIG. 1.

Each of the thus obtained samples had a size of 3.2 mm×1.6 mm×0.6 mm. The number of layers sandwiched between the internal electrode layers was four, the thickness was 3.0 μm, and the thickness of the internal electrode layers was 1.0 μm.

Each of the obtained capacitor samples was used to evaluate the specific permittivity (specific permittivity at time of addition of subcomponents) and capacity-temperature characteristic by the following methods.

Specific Permittivity at Time of Addition of Subcomponents

The specific permittivity (no units) at the time of addition of the subcomponents was calculated for each capacitor sample from the electrostatic capacity pleasured at a reference temperature of 25° C. by a digital LCR meter (made by YHP, 4274A) under conditions of an input signal level (measurement voltage) of 1.0 Vrms at a frequency 1 kHz. The results are shown in Table 1.

Capacity-Temperature Characteristic

Each capacitor sample was measured for electrostatic capacity at temperatures of −25° C. and 85° C. and the rates of change ΔC₋₂₅/C₂₀ and ΔC₈₅/C₂₀(unit: %) of the electrostatic capacities at −25° C. and 85° C. with respect to the electrostatic capacity at the reference temperature 20° C., wherein it was found that each sample is within ±10% and satisfies the B characteristic of the EIAJ standard.

TABLE 1

| | | Specific | | | | Average particle | |
|---|---|---|---|---|---|---|---|
| | Method of | surface area | Heat | Specific | Specific | diameter BaTiO₃ | |
| | synthesis of | of BaTiO₃ | treatment | permittivity | permittivity at | of powder after | Residual |
| Sample | BaTiO₃ | powder | temp. | of BaTiO₃ | addition of | heat treatment | CO₂ rate |
| no. | powder | [m²/g] | [° C.] | alone | subcomponents | [μm] | [%] |
| 1 | Oxalate | 2.8 | 380 | 3000 | 2400 | 0.6 | 0.08 |
| | method | | | | | | |
| 2 | Oxalate | 2.8 | 400 | 3300 | 2550 | 0.6 | 0.00 |
| | method | | | | | | |
| 3 | Oxalate | 2.8 | 420 | 3500 | 2550 | 0.6 | 0.00 |
| | method | | | | | | |
| 4 | Oxalate | 2.8 | 700 | 3700 | 2800 | 0.6 | 0.00 |
| | method | | | | | | |
| 5 | Oxalate | 2.8 | 980 | 3750 | 2850 | 0.6 | 0.00 |
| | method | | | | | | |
| 6 | Oxalate | 2.8 | 1000 | 3800 | 2900 | 0.6 | 0.00 |
| | method | | | | | | |
| 7 | Oxalate | 2.8 | 1020 | 4100 | 3300 | 0.8 | 0.00 |
| | method | | | | | | |

Table 1 shows the heat treatment temperature for removal of the gas ingredient, the specific permittivity of the BaTiO₃ alone, the specific permittivity at the time of addition of the subcomponents, the average particle diameter of the BaTiO₃ powder after heat treatment, and the residual CO₂ rate in the BaTiO₃.

From Table 1, Sample No. 1 having a heat treatment temperature for removal of the gas ingredient of 380° C. had a residual CO₂ rate in the BaTiO₃ of 0.08%, that is, CO₂ remained in the BaTiO₃. Further, in this Sample No. 1, cracking due to escape of due to the expansion of CO₂ at the time of firing also occurred. Note that the reason for these is believed to be that the heat treatment temperature is too low.

As opposed to this, Sample Nos. 2 to 6 having heat treatment temperatures for removal of the gas ingredient of 400 to 1000° C. all had residual CO₂ rates in the BaTiO₃ of 0.00%, that is, compared with Sample No. 1 having a heat treatment temperature of 380° C., had higher specific permittivity of the BaTiO₃ alone and at time of addition of subcomponents. Further, these Sample Nos. 2 to 6 had average particle diameters of the BaTiO₃ powder substantially equal to Sample No. 1 having a heat treatment temperature of 380° C., that is, no particle growth due to heat treatment was observed.

Further, Sample No. 7 having a heat treatment temperature of 1020° C. was improved in specific permittivity, but ended up with particle growth occurring due to the heat treatment. As a result, the obtained capacitor sample deteriorated in IR defect rate.

### Example 2

A starting material comprised of a BaTiO₃ powder synthesized by the hydrothermal synthesis method (specific surface area of 4.0 m²/g, Ba/Ti=1.005) was prepared, then this BaTiO₃ powder was heat treated to remove the gas ingredients under the same conditions as in Example 1. Otherwise, the same procedure was followed as in Example 1 to prepare the main component material (BaTiO₃). Further, each obtained main component material (BaTiO₃) was evaluated in the same way as Example 1. The results are shown in Table 2.

Further, each obtained main component material and the subcomponent materials comprised of CaO, SiO₂, Y₂O₃, MgO, V₂O₅, and MnO were used for the same methods as in Example 1 to prepare a dielectric ceramic composition material. Next, this dielectric ceramic composition material was used to prepare a multilayer ceramic capacitor. Further, each obtained capacitor sample was evaluated in the sane way as in Example 1. The results are shown in Table 2.

Note that in Example 2, the amounts of addition of the subcomponent materials were adjusted to give the following ratios with respect to 100 mol of the main components in the composition after firing:
CaO: 1.24 mol
SiO₂: 2.95 mol
Y₂O₃: 1.96 mol
MgO: 0.54 mol
V₂O₅: 0.03 mol
MnO: 0.20 mol

Further, the firing conditions were changed to temperatures suitable for the BaTiO₃ powder synthesized by the hydrothermal synthesis method, that is, conditions giving the largest specific permittivity. Specifically, the firing temperatures of the BaTiO₃ alone were made 1250 to 1270° C. and the firing temperature at the time of addition of the subcomponents (green chip) was made 1275° C.

TABLE 2

| | | Specific | | | | Average particle | |
|---|---|---|---|---|---|---|---|
| | Method of | surface area | Heat | Specific | Specific | diameter BaTiO₃ | |
| | synthesis of | of BaTiO₃ | treatment | permittivity | permittivity at | of powder after | Residual |
| Sample | BaTiO₃ | powder | temp. | of BaTiO₃ | addition of | heat treatment | CO₂ rate |
| no. | powder | [m²/g] | [° C.] | alone | subcomponents | [μm] | [%] |
| 11 | Hydrothermal | 4.0 | 380 | 5600 | 3300 | 0.3 | 0.15 |
| | synthesis | | | | | | |
| | method | | | | | | |
| 12 | Hydrothermal | 4.0 | 400 | 6050 | 3500 | 0.3 | 0.00 |
| | synthesis | | | | | | |
| | method | | | | | | |
| 13 | Hydrothermal | 4.0 | 420 | 7300 | 3500 | 0.3 | 0.00 |
| | synthesis | | | | | | |
| | method | | | | | | |
| 14 | Hydrothermal | 4.0 | 700 | 7500 | 3650 | 0.3 | 0.00 |
| | synthesis | | | | | | |
| | method | | | | | | |
| 15 | Hydrothermal | 4.0 | 980 | 7650 | 3700 | 0.3 | 0.00 |
| | synthesis | | | | | | |
| | method | | | | | | |
| 16 | Hydrothermal | 4.0 | 1000 | 7700 | 3750 | 0.3 | 0.00 |
| | synthesis | | | | | | |
| | method | | | | | | |
| 17 | Hydrothermal | 4.0 | 1020 | 8050 | 4000 | 0.5 | 0.00 |
| | synthesis | | | | | | |
| | method | | | | | | |

From Table 2, it can be confirmed that even when using main component materials comprised of a BaTiO₃ power synthesized by the hydrothermal synthesis method, similar trends can be obtained.

### Example 3

A starting material comprised of a BaTiO₃ powder synthesized by the solid phase method (specific surface area of 4.2 m²/g, Ba/Ti=1.017) was prepared, then this BaTiO₃ powder was heat treated to remove the gas ingredients under the same conditions as in Example 1. Otherwise, the same procedure was followed as in Example 1 to prepare the main component material (BaTiO₃). Further, each obtained main component material (BaTiO₃) was evaluated in the same way as Example 1. The results are shown in Table 3.

Note that the BaTiO₃ powder was synthesized by the solid phase method by the following method. First, a BaCO₃ powder and TiO₂ powder were prepared, then these powders were wet mixed by a ball mill for 19 hours, then calcined at 1000° C. for 2 hours to obtain a calcined material. Next, the obtained calcined material was wet crushed by a ball mill for 19 hours to obtain a BaTiO₃ powder adjusted to a specific surface area of 4.2 m²/g.

Further, each obtained main component material and the subcomponent materials comprised of CaO, SiO₂, Y₂O₃, MgO, and V₂O₅ were used for the same method as in Example 1 to prepare a dielectric ceramic composition material. Next, this dielectric ceramic composition material was used to prepare a multilayer ceramic capacitor. Further, each obtained capacitor sample was evaluated in the same way as in Example 1. The results are shown in Table 3.

Note that in Example 3, the amounts of addition of the subcomponent materials were adjusted to give the following ratios with respect to 100 mol of the main components in the composition after firing:
CaO: 0.24 mol
SiO₂: 0.56 mol
Y₂O₃: 0.56 mol
MgO: 0.75 mol
V₂O₅: 0.10 mol

Further, the firing conditions were changed to temperatures suitable for the BaTiO₃ powder synthesized by the solid phase method, that is, conditions giving the largest specific permittivity. Specifically, the firing temperatures of the BaTiO₃ alone were made to 1250° C. 1270° C. and the firing temperature at the time of addition of the subcomponents (green chip) was made 1250° C.

TABLE 3

| | | Specific | | | | Average particle | |
|---|---|---|---|---|---|---|---|
| | Method of | surface area | Heat | Specific | Specific | diameter BaTiO₃ | |
| | synthesis of | of BaTiO₃ | treatment | permittivity | permittivity at | of powder after | Residual |
| Sample | BaTiO₃ | powder | temp. | of BaTiO₃ | addition of | heat treatment | CO₂ rate |
| no. | powder | [m²/g] | [° C.] | alone | subcomponents | [μm] | [%] |
| 21 | Solid phase | 4.2 | 380 | 5400 | 3200 | 0.3 | 0.19 |
| | method | | | | | | |
| 22 | Solid phase | 4.2 | 400 | 5900 | 3350 | 0.3 | 0.00 |
| | method | | | | | | |
| 23 | Solid phase | 4.2 | 420 | 6500 | 3350 | 0.3 | 0.00 |
| | method | | | | | | |
| 24 | Solid phase | 4.2 | 700 | 7200 | 3500 | 0.3 | 0.00 |
| | method | | | | | | |
| 25 | Solid phase | 4.2 | 980 | 7350 | 3550 | 0.3 | 0.00 |
| | method | | | | | | |
| 26 | Solid phase | 4.2 | 1000 | 7450 | 3600 | 0.3 | 0.00 |
| | method | | | | | | |
| 27 | Solid phase | 4.2 | 1020 | 7800 | 3800 | 0.5 | 0.00 |
| | method | | | | | | |

From Table 3, it can be confirmed that even when using main component materials comprised of a BaTiO₃ powder synthesized by the solid phase method, similar trends can be obtained.

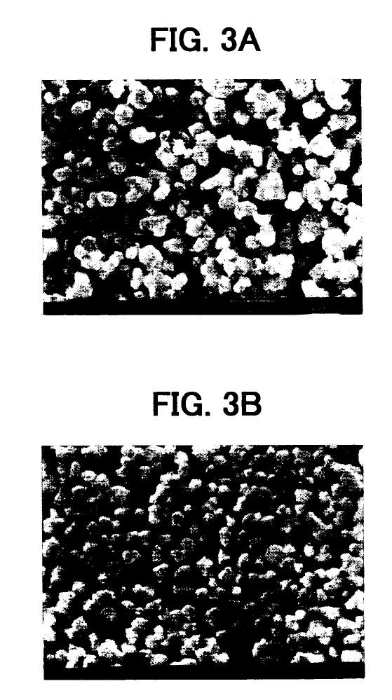

Note that FIG. 3A and FIG. 3B show SEM photos of BaTiO₃ powder synthesized by the solid phase method. Here, FIG. 3A shows a SEM photo of BaTiO₃ powder before heat treatment, while FIG. 3B shows a SEM photo of BaTiO₃ powder (Sample No. 24) after heat treatment for removal of the gas ingredient. From these SEM photos, it can be confirmed that the heat treatment for removal of the gas ingredient does not change the particle diameter of the main component material at all.

### Example 4

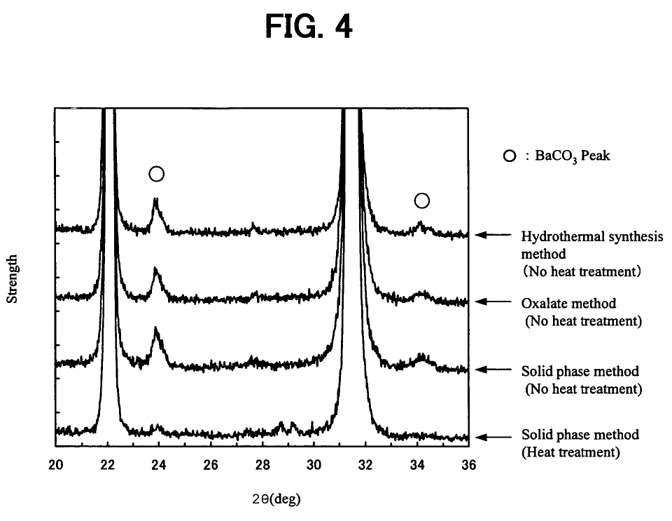

The BaTiO₃ powders before heat treatment used in Examples 1 to 3 and the BaTiO₃ powder after heat treatment for removal of the gas ingredient (Sample No. 24 of Example 3) were used for X-ray diffraction measurement. The diffraction patterns obtained from the measurement results are shown in FIG. 4.

Note that the X-ray diffraction measurement was performed using a powder X-ray (Cu—Kα ray) diffraction apparatus between 2θ=20 to 36° under X-ray generation conditions of 50 kV-300 mA, a scan width of 0.01°, and a scan rate of 0.1°/min. and under X-ray detection conditions of a horizontal slit of 10 mm, a dispersion slit of 0.3 mm, and an open receiving slit.

From FIG. 4, it can be confirmed that BaTiO₃ powder before heat treatment, regardless of the method of synthesis, has diffraction peaks due to BaCO₃ (peaks near 2θ=24 ° and 34°) and contains a gas ingredient of CO₂ in the form of a barium salt. As opposed to this, it can be confirmed that the BaTiO₃ powder after heat treatment for removal of the gas ingredient lost the diffraction peak due to the BaCO₃ and did not substantially contain this gas ingredient.

### Example 5

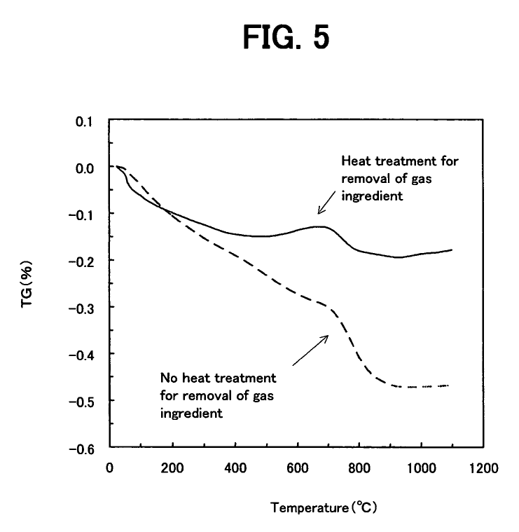

The BaTiO₃ powder before heat treatment used in the above Example 3 and the BaTiO₃ powder after heat treatment for removal of the gas ingredient (Sample No. 24 of Example 3) were used for TG-DTA measurement. The TG curves obtained as a result of the measurement are shown in FIG. 5. Note that the conditions for TG-DTA measurement were a measurement atmosphere of the air atmosphere and a rate of temperature rise of 10° C./min.

From FIG. 5, the BaTiO₃ powder before heat treatment (broken line in the figure) showed a loss of weight due to the escape of CO₂ near 700 to 900° C. As opposed to this, the BaTiO₃ powder after heat treatment for removal of the gas ingredient (solid line in the figure) did not show any loss of weight due to the escape of this CO₂.

1. A production method of a dielectric ceramic composition having a main component containing a compound having a perovskite crystal structure of the general formula ABO₃ (where, A is at least one type of element selected from Ba, Ca, Sr, and Mg, and B is at least one type of element selected from Ti, Zr, and Hf), having
a step of synthesizing an ABO₃ powder by a liquid phase method,
a step of heat treating said synthesized ABC) powder to remove gas ingredients contained in said ABO₃ powder, and
a step of firing a dielectric ceramic composition material including said ABO₃ powder from which the gas ingredient has been removed.

2. The production method of a dielectric ceramic composition as set forth in claim 1, wherein said liquid phase method is a method selected from an oxalate method, hydrothermal synthesis method, and alkoxide method.

3. A production method of a dielectric ceramic composition having a main component containing a compound having a perovskite crystal structure of the general formula ABO₃ (where, A is at least one type of element selected from Ba, Ca, Sr, and Mg, and B is at least one type of element selected from Ti, Zr, and Hf), having
a step of synthesizing an ABO₃ powder by a solid phase method,
a step of heat treating said synthesized ABC) powder to remove gas ingredients contained in said ABO₃ powder, and
a step of firing a dielectric ceramic composition material including said ABO₃ powder from which the gas ingredient has been removed.

4. The production method of a dielectric ceramic composition as set forth in claim 3, further having a step of crushing said ABO₃ powder synthesized by the solid phase method before heat treating said ABO₃ powder.

5. A production method of a dielectric ceramic composition as set forth in claim 1, wherein the heat treatment temperature when heat treating said ABO₃ powder is 400 to 1000° C.

6. A production method of a dielectric ceramic composition as set forth in claim 3, wherein the heat treatment temperature when heat treating said ABO₃ powder is 400 to 1000° C.
